(19) United States
(12) Patent Application Publication
(10) Pub. No.: US 2004/0016745 A1
(43) Pub. Date: Jan. 29, 2004

(54) Method for achieving process uniformity by modifying thermal coupling between heater and substrate

(75) Inventors: David P. Sun, Mountain View, CA (US); Steven Glanoulakis, Pleasanton, CA (US)

Correspondence Address: Patent Counsel, M/S 2061, APPLIED MATERIALS, INC., Legal Affairs Department, P.O. Box 450A, Santa Clara, CA, 95052, US

(73) Assignee: Applied Materials, Inc., Santa Clara, CA

(21) Appl. No.: 10/435,118

(22) Filed: May 9, 2003

Related U.S. Application Data
(60) Provisional application No. 60/399,516, filed on Jul. 29, 2002.

(51) Int. Cl. H05B 1/02

(52) U.S. Cl. 219/444.1; 118/725

(57) ABSTRACT

The present invention is directed to achieving a desired the process uniformity of a substrate by modifying the distribution of thermal coupling between the substrate and the heater which heats the substrate. In one embodiment, the method comprises establishing a correlation between a uniformity parameter of the process to be performed on the substrate and a surface feature of a heater surface of the heater which is in substantially full contact with a bottom surface of the substrate. The method further comprises determining a desired surface feature of the heater surface of the heater in substantially full contact with the substrate, based on the correlation between the uniformity parameter of the process to be performed on the substrate and the surface feature of the heater surface of the heater, to achieve a preset process uniformity of the uniformity parameter.

### CROSS-REFERENCES TO RELATED APPLICATIONS

This application is based on and claims the benefit of U.S. Provisional Patent Application No. 60/399,516, filed Jul. 29, 2002, the entire disclosure of which is incorporated herein by reference.

### BACKGROUND OF THE INVENTION

The present invention relates generally to a substrate heater for heating substrates and, more particularly, to a method of achieving a desired process uniformity of a layer formed on a substrate which is heated by the substrate heater.

One of the primary steps in the fabrication of modern semiconductor devices is the formation of a thin film on a semiconductor substrate by chemical reaction of gases. Such a deposition process is referred to as chemical vapor deposition (CVD). Conventional thermal CVD processes supply reactive gases to the substrate surface where heat-induced chemical reactions can take place to produce the desired film. Plasma enhanced CVD processes promote the excitation and/or dissociation of the reactant gases by the application of radio frequency (RF) energy to the reaction zone proximate the substrate surface thereby creating a plasma of highly reactive species. The high reactivity of the released species reduces the energy required for a chemical reaction to take place, and thus lowers the required temperature for such CVD processes.

Substrate heaters are used to support and heat a substrate during substrate processing such as the formation of a layer on the substrate. The substrate rests above the heater surface of the heater and heat is supplied to the bottom of the substrate. Some substrate heaters are resistively heated, for example, by electrical heating elements such as resistive coils disposed below the heater surface or embedded in a plate having the heater surface. The heat from the substrate heater is the primary source of energy in thermally driven processes such as thermal CVD for depositing layers including undoped silicate glass (USG), doped silicate glass (e.g., borophosphosilicate glass (BPSG)), and the like. Substrate temperature distribution often affects the process uniformity, such as the film uniformity of a layer formed in the substrate (e.g., film thickness, dopant concentration, refractive index, or the like).

Standard heaters do not employ a vacuum chuck to maintain the substrate on the heater surface. The heater temperature profile of a standard heater typically is highly correlated with the wafer temperature profile, as the heater drives the wafer temperature. The conventional way of affecting wafer temperature uniformity is to change the surface temperature distribution of the heater. To do so, one would redesign the electrical heating element. This is generally an expensive and time-consuming process. In addition, the design of the heating element has certain limitations. For example, due to ceramic cracking problems, a ceramic heater is typically center-hot, which causes the substrate to be center-hot. Such a heater is not suitable for processes in which the substrate should be center-cold or which should have a uniform temperature distribution.

For heaters that employ a vacuum chuck to draw the substrate toward the heater surface by vacuum, some have employed a minimum contact heater to minimize the contact between the heater surface and the substrate in order to reduce film variations. This may be done, for example, by using many vacuum grooves on the heater surface or providing dimples on the heater surface. Heaters with substantially more contact between the heater surface and the substrate are also known. For example, a maximum contact heater has a heater surface that makes substantially full contact with the bottom surface of the substrate. Due to the low pressure gas between the substrate and the heater surface of the heater, the heat transfer from the heater to the substrate is more complex.

### BRIEF SUMMARY OF THE INVENTION

The present invention is directed to achieving a desired process uniformity of a substrate by modifying the distribution of thermal coupling between the substrate and the heater which heats the substrate. The process uniformity is measured by a uniformity parameter, which may be the film uniformity of a layer to be formed on the substrate, such as film thickness, dopant concentration, refractive index, or the like. In some cases, the uniformity parameter may be closely or directly related to the temperature of the substrate.

In some embodiments, the method modifies the surface feature of the heater surface facing the substrate to control the substrate temperature distribution or other uniformity parameter distribution. The heater surface is in substantially full contact with the bottom surface of the substrate. Typically, at least about 90% of the bottom surface of the substrate is in contact with the heater surface. The surface feature of the heater surface comprises, for example, the surface roughness of the heater surface and the configuration of one or more vacuum grooves on the heater surface, including the vacuum groove depth, pattern, length, and the like. By changing the pressure distribution of the interfacial gas between the heater surface and the substrate, one can alter the thermal coupling between the heater surface and the substrate to achieve a desired substrate temperature distribution, or other desired uniformity parameter distributions.

The heater surface design is carried out desirably by numerically simulating the process conditions and heat transfer between the heater and the substrate, using experimentally obtained process temperature and pressure data. The numerical simulation produces a pressure distribution in the space between the heater surface and the substrate. Given the pressure distribution, gas type, and surface roughness, one can estimate the state of the gas by calculating the Knudsen number to determine whether the interfacial gas in the space is in a rarefied (free molecular) state or a continuum state at various locations. From the state of the gas, one can estimate the thermal conductivity of the gas and compute the thermal coupling between the heater surface and the entire bottom surface of the substrate. The substrate temperature can then be calculated. For certain uniformity parameters, the uniformity parameter distribution of the substrate can be computed based on experimental data correlating the substrate temperature and the uniformity parameter distribution of the substrate. Numerical iteration can be used to adjust the surface feature of the heater surface to obtain the desired uniformity parameter distribution of the substrate.

An aspect of the present invention is directed to a method of achieving a desired process uniformity of processing a substrate which is heated by a heater. The method comprises establishing a correlation between a uniformity parameter of the process to be performed on the substrate and a surface feature of a heater surface of the heater which is in substantially full contact with a bottom surface of the substrate. The method further comprises determining a desired surface feature of the heater surface of the heater in substantially full contact with the substrate, based on the correlation between the uniformity parameter of the process to be performed on the substrate and the surface feature of the heater surface of the heater, to achieve a preset process uniformity of the uniformity parameter.

In accordance with another aspect of the invention, a method of performing a process with a desired uniformity on a substrate comprises providing a heater to heat the substrate in a process chamber. The heater has a heater surface in substantially full contact with a bottom surface of the substrate. The heater surface has a surface feature which has been determined to achieve a preset uniformity of a uniformity parameter of a process to be performed on the substrate under a set of process conditions, based on a correlation between the uniformity parameter of the process to be performed on the substrate and the surface feature of the heater surface. The process is performed on the substrate having the preset uniformity of the uniformity parameter according to the set of process conditions.

Another aspect of the invention is directed to a method of achieving a desired uniformity of a process to be performed on a substrate which is heated by a heater. The method comprises modifying a heater surface of the heater in substantially full contact with a bottom surface of the substrate according to a surface feature which has been determined to achieve a preset uniformity of a uniformity parameter of a process to be performed on the substrate. This is accomplished by performing numerical simulation each by simulating heat transfer between the heater and the substrate for the process to be performed on the substrate; varying the surface feature of the heater surface; and calculating the uniformity parameter of the process to be performed on the substrate, based on the correlation between the uniformity parameter of the process to be performed on the substrate and the surface feature, until the preset uniformity is achieved for a simulated surface feature of the heater surface.

In accordance with another aspect of the invention, a heater for heating a substrate in a chamber for forming a layer on the substrate from a process gas comprises a heater surface configured to support the substrate. The heater surface includes at least one vacuum port to be coupled to a vacuum source to draw a bottom surface of the substrate toward the heater surface. The heater surface has at least one vacuum groove extending from the at least one vacuum port. The heater surface has a surface topography to provide substantially full contact between the heater surface and the bottom surface of the substrate and a Knudsen number distribution of a gas between the heater surface and the bottom surface of the substrate which is greater than about 10 over a substantial portion of the bottom surface of the substrate. The at least one vacuum groove has a depth and a pattern selected to produce a pressure distribution which gradually increases from a center region to a periphery of the heater surface.

### BRIEF DESCRIPTION OF THE DRAWINGS

FIG. 1 is a plan view of a heater surface of a heater for supporting a substrate according to an embodiment of the present invention;

FIG. 2 is a diagram showing experimental results to illustrate the effect of vacuum groove depth on the substrate temperature distribution; and

FIG. 3 is a flow diagram illustrating a method of modifying the surface feature of the heater surface to improve process uniformity according to an embodiment of the invention.

### DETAILED DESCRIPTION OF THE INVENTION

Instead of changing the heater element design, the present invention alters the substrate temperature distribution by modifying the distribution of thermal coupling between the heater and the substrate.

For a vacuum-chucked substrate heater in substantially full contact with the bottom surface of the substrate (e.g., at least about 90% contact), the distribution of thermal coupling between the heater and the substrate is highly related to the gas pressure distribution in the space or gap between the heater surface and the bottom surface of the substrate. The interfacial gas may be in rarefied (free molecular) state or a continuum state at different locations of the gap. The gap is formed by the free space between roughness elements on the two surfaces. The regions of no contact are occupied by vacuum grooves. In the rarefied state, free molecular flow exists, where the Knudsen number (the ratio of the mean free path to the spacing) is greater than about 10. The thermal conductivity of the gas is dependent on pressure, and increases with pressure. For instance, if the mean free path between molecules is 1000 micro-inches and the gap spacing is 40 micro-inches, the Knudsen number is 25 and the gas is in the rarefied state. In a continuum state wherein the Knudsen number is less than 10, more typically substantially less than 10, thermal conductivity of the gas does not depend on pressure. The thermal conductivity of a continuum gas is at least one order of magnitude higher than a gas in the free molecular state.

In a vacuum-chucked heater, the gap spacing is kept small to achieve maximum contact (e.g., at least about 90% contact) between the substrate and the heater surface so that the interfacial gas in the gap is largely in the rarefied state. Typically, the Knudsen number distribution is such that the value is greater than about 10 over substantially the entire contact region (e.g., at least about 90% of the bottom surface of the substrate). The gap spacing is the surface roughness of the heater surface. The surface roughness is often represented by the average gap spacing. The vacuum grooves or channels are formed in a central region of the heater surface. The vacuum groove depth is substantially greater than the gap spacing, typically by several orders of magnitude. In the peripheral region outside the vacuum channels, the pressure in the gap is higher than the pressure in the central region. As a result, the substrate temperature tends to be higher in the peripheral region, due to the higher thermal conductivity resulting from the higher pressure in the peripheral region. This is observed experimentally as an abrupt temperature rise in the substrate over the peripheral region as the pressure changes from about 5 Torr in the central region to about 400 Torr (chamber process pressure) rather abruptly near the edge of the substrate, while the heater surface does not exhibit such a temperature increase. The abrupt rise in temperature indicates a rapid transition of the gas from a free molecular regime in the central region of the gap to a continuum toward the edge of the substrate.

One approach to reduce the abruptness of the temperature rise to achieve a more uniform temperature distribution is to broaden the transition of the gas from free molecular state to continuum state over a larger distance. This can be accomplished by gradually increasing the pressure in the gap between the substrate and the heater surface radially from the center to the outer vacuum groove(s). The configuration of the vacuum groove(s) affects the pressure distribution, and the configuration includes the vacuum groove depth, pattern, length, and the like. For instance, a decrease in the vacuum groove depth will increase the pressure gradient between the central region and the location of the outer vacuum groove(s) in the gap between the substrate and the heater surface, thereby producing a more uniform thermal coupling. The pressure rise inboard of the outer vacuum groove(s) can be increased significantly by reducing the depth of the vacuum groove(s) in the radial direction.

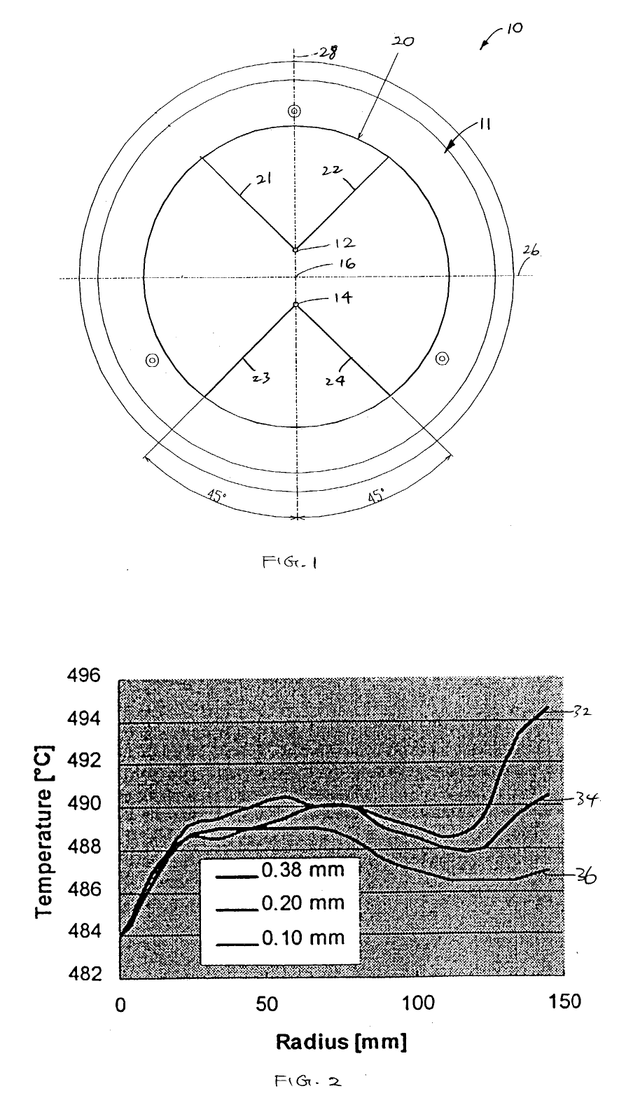

FIG. 1 shows an exemplary embodiment of a heater surface 11 of a heater 10 having a pair of vacuum ports or apertures 12, 14 which are disposed in a central region and on opposite sides of the center 16 of the heater surface 11. The heater 10 includes an outer annular ledge disposed on a different plane from the plane of the heater surface 11. An outer circular vacuum groove 20 is coupled with the vacuum ports 12, 14 by a plurality of linear vacuum grooves each extending generally radially from one of the vacuum ports to the outer vacuum groove 20. The linear vacuum grooves 21, 22 extend from the vacuum port 12 to the outer vacuum groove 20, and are disposed about 90° apart from one another. Similarly, the linear vacuum grooves 23, 24 extend from the vacuum port 14 to the outer vacuum groove 20, and are disposed about 90° apart from one another. The vacuum groove pattern is symmetrical with respect to two axes 26, 28. In the specific embodiment, the outer vacuum groove 20 is about 9.118 inches in diameter for supporting a 300 mm substrate, and the width of the vacuum grooves is about 0.03 inch. Of course, the vacuum groove configuration including the size and pattern can be different in other embodiments.

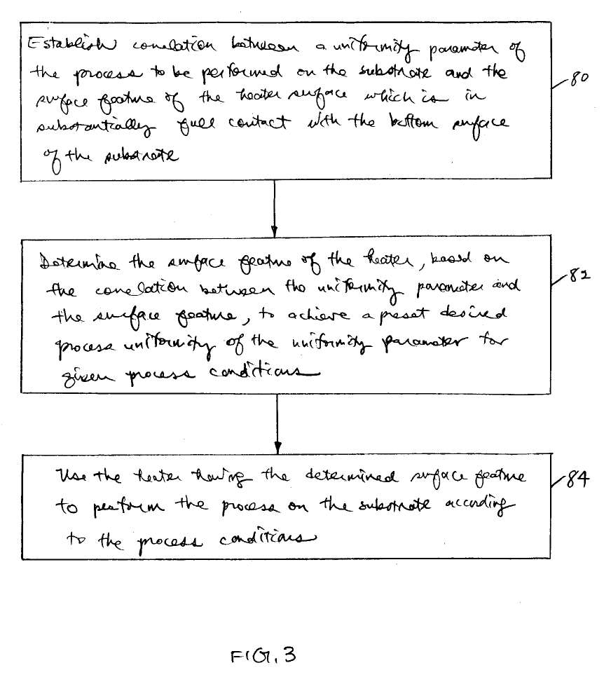

FIG. 2 shows experimental results to illustrate the effect of vacuum groove depth on the substrate temperature distribution. The substrate surface temperature can be measured using any suitable technique, such as an infrared (IR) inspection method. The radial temperature distribution (plot 32) of the substrate exhibits an abrupt increase toward the edge for a vacuum groove depth of about 0.38 mm. When the vacuum groove depth is reduced to about 0.2 mm (plot 34), the increase in temperature is less abrupt toward the edge. The uniformity is significantly affected by reducing the vacuum groove depth to about 0.1 mm (plot 36), resulting in more than a 50% improvement in overall temperature uniformity from a 14.5° C. range to a 7.5° C. range. Other ways of configuring the vacuum groove(s) to improve substrate temperature uniformity include, for example, adding grooves near the center of the heater surface. Numerical simulation and experimental results have shown that changing the vacuum groove configuration such as the groove depth can alter the temperature uniformity of the substrates in areas non-local to the vacuum groove. This is believed to be due to the change in pressure distribution throughout the gap between the substrate and the heater surface to increase more gradually from the center region to the periphery without significant abrupt jumps in pressure, which has a global effect on the thermal coupling between the substrate and the heater surface.

The pressure distribution in the gap is also affected by the gap spacing of the heater surface (i.e., surface roughness) which has an effect on the Knudsen number distribution. By adjusting the surface roughness and vacuum groove configuration, the desired thermal coupling can be obtained to achieve a preset process uniformity of a uniformity parameter, which may be a film thickness, dopant concentration, or refractive index of a layer to be formed on the substrate, or the like. The desired uniformity based on the particular uniformity parameter may be achieved by correlating the uniformity parameter with the thermal coupling between the heater and the substrate (as defined by the surface feature of the heater surface) and modifying the surface feature of the heater surface.

This approach has broad applicability in thermal processes such as thermal CVD, but is also applicable to any process that uses a heater to control the substrate temperature. Generally, the approach is most useful where thermal conduction instead of radiation is the primary mode of heat transfer via the gas between the heater and the substrate. Moreover, different surface feature designs can be used for the same heater element design. This greatly reduces the risk, cost, and lead time to test different iterations. For instance, a heater can have its surface features modified and tested at a low cost (e.g., about $1000) in a matter of days. Existing heaters can be retrofitted with a different surface features as well.

To expedite the surface feature design process, numerical simulations are performed to simulate the process conditions and heat transfer between the heater and the substrate, and obtain a simulated temperature distribution of the substrate for each simulated surface feature design. Based on experimental data correlating the temperature distribution of the substrate and the uniformity parameter distribution of the substrate, the uniformity parameter distribution of the substrate can be calculated from the simulated temperature distribution of the substrate. Numerical iteration can be used to adjust the surface feature to obtain the desired uniformity parameter distribution of the substrate. The surface feature of the heater may then be constructed and tested to confirm the quality of the numerical simulation. This method can predictably manipulate the uniformity parameter such as film thickness or dopant profile to improve the process uniformity of the substrate processing apparatus. The method not only can reduce the range of the uniformity parameter to a narrower range, but can manipulate the thermal coupling to achieve a desired uniformity parameter distribution.

The surface feature of the heater surface is modified to alter the thermal coupling between the heater and the substrate, and change the substrate temperature distribution. More specifically, the surface roughness of the heater surface acts to adjust the gap spacing and hence the Knudsen number distribution. The Knudsen number distribution defines the state of the interfacial gas. The vacuum groove configuration is modified to adjust the pressure distribution in the gap between the substrate and the heater surface. The state of the gas and the pressure distribution in the gap determine the thermal conductivity of the gas and the thermal coupling between the heater and the substrate, which is in turn correlated with a uniformity parameter of the process to be performed on the substrate.

Because the heater surface construction is one of the last steps in heater manufacturing, it is relatively simple to change to provide the surface feature obtained by the present method. Furthermore, the present method provides added flexibility by allowing the heater surface feature design to be “tuned” for specific processes. For example, different carrier gases can affect the thermal conduction and heat transfer between the heater and the substrate. Helium as a carrier gas is more thermally conductive than nitrogen as a carrier gas. Different pressure and temperature conditions in the chamber also affect the state of the gas and the pressure distribution in the gap. The numerical simulation can take these variables into account in simulating the process conditions and heat transfer between the heater and the substrate.

FIG. 3 illustrates the method of modifying the surface feature of the heater surface to improve process uniformity according to an embodiment of the present invention. In step 80, a correlation is established between a uniformity parameter of the process to be performed on the substrate and the surface feature between the substrate and the heater surface which is in substantially full contact with the bottom surface of the substrate. The correlation is established by determining a correlation between the uniformity parameter of the process and the temperature of the substrate, and determining a correlation between the temperature of the substrate and the surface feature of the heater surface. To determine the correlation between the uniformity parameter of the process and the temperature of the substrate, test data are obtained from a plurality of tests each conducted by performing the process on a substrate while varying the temperature of the substrate. The uniformity parameter is measured, and is correlated with the temperature of the substrate. To determine the correlation between the temperature of the substrate and the surface feature of the heater surface, test data are obtained from a plurality of tests each conducted by performing the process on a substrate while varying the surface feature of the substrate. The temperature of the substrate is measured, and is correlated with the surface feature of the heater surface.

In some cases, the uniformity parameter of the process is the thicknesses of some layers such as an undoped silicate glass layer that are formed on the substrate. The thicknesses are highly related to the substrate temperature. To obtain a uniform thickness, the substrate temperature should generally be uniform as well. Other chamber conditions such as gas flow also affect the substrate temperature and chemical distribution, which also affects film thickness.

Referring to FIG. 3, the next step 82 after establishing a correlation between the uniformity parameter of the process and the surface feature of the heater surface is to determine a desired surface feature of the heater surface, based on the correlation between the uniformity parameter and the surface feature of the heater surface, to achieve a preset desired process uniformity of the uniformity parameter for a given set of process conditions. For instance, the preset desired process uniformity may be a substrate temperature range of no more than a maximum range (e.g., 10° C.) or a film thickness range of no more than a maximum range (e.g., 1%).

Numerical simulation is used to assist in the determination of the surface feature of the heater surface by simulating the process conditions and heat transfer between the heater and the substrate for the process which is to be performed on the substrate. Different surface features of the heater surface having different vacuum groove configurations such as depths, patterns, and lengths can be tried numerically. The uniformity parameter of the process can be calculated from the result of the numerical simulation based on the correlation between the uniformity parameter of the process and the surface feature, until the preset desired uniformity is achieved for a simulated surface feature of the heater. The experimental data and analytical models of heat transfer and thermal coupling between the heater surface and the substrate, which are employed to establish the correlation between the uniformity parameter and the surface feature of the heater surface, are used to guide the numerical simulation of the process for different heater surface features.

Any suitable numerical simulation scheme, such as finite elements, computational fluid dynamics, and the like, may be used. In one embodiment, coupled fluid and thermal modeling is used to simulate and compute the thermal coupling between the substrate and the heater. This coupled approach is desirable because at low pressures the interfacial gas in the gap between the substrate and the heater surface may be in a rarefied state and the pressure distribution can affect the thermal conductivity of the interfacial gas. The interfacial gas flow is simulated using CFDRC V6.6 software. Experimental temperature (temperature across the substrate and the heater surface alone) and pressure (backside and chamber pressure) data are used for the setup in the numerical simulation. The output from the CFDRC simulation is the in-plane pressure distribution between the heater surface and the substrate. Knowing the pressure distribution and the surface roughness of the heater surface, one can estimate the state of the gas (rarefied or continuum) by calculating the Knudsen number distribution. For a rarefied condition, kinetic theory is used to estimate the thermal conductivity of the interfacial gas. See, e.g., J. P. Holman, “Thermodynamics,” McGraw-Hill Co., 1980, at Chapter 9. For a continuum condition, the pressure-independent thermal conductivity of the gas is used, and can be obtained from look-up tables.

After the thermal conductivity of the gas is determined, a finite element analysis can be used to compute the substrate temperature profile. One suitable tool is the finite element analysis software ANSYS v5.6.2. A finite element model of the heater, the substrate, and the interfacial gas is constructed. The heat transfer modes included in the model are solid state conduction in the heater and the substrate, and combined stagnant gas conduction and surface-to-surface radiation as the thermal coupling between the heater and the substrate. Convection is neglected in the gas due to the small space between the heater and the substrate. The heater temperature is controlled with a specified radial temperature distribution corresponding to experimental measurements. The boundary conditions from the substrate and heater include convection and radiation to the chamber components. Given the thermal coupling, one can calculate the substrate temperature distribution based on the heater temperature distribution. The substrate temperature distribution may be compared with experimental temperature data for verification.

From prior knowledge (experimental and theoretical), one can estimate the substrate temperature range that would produce the desired process uniformity. For instance, prior knowledge about the film deposition rate and substrate temperature can be used to determine the substrate temperature range that is permissible to meet the preset desired film thickness tolerance. This can be used to guide the numerical simulation to achieve the desired substrate temperature profile for a preset process uniformity.

To produce the desired substrate temperature profile, different surface features including vacuum groove configurations and surface roughness conditions are analyzed. The different surface features are simulated in the coupled fluid and thermal modeling. After simulating several surface feature configurations, a correlation between surface features (e.g., vacuum groove depth and pattern, and surface roughness) and the effects on substrate temperature is developed. This correlation guides further surface feature designs and iterations to produce the desired uniformity parameter profile (e.g., substrate temperature distribution, film thickness profile, or the like).

After the surface feature of the heater surface is obtained in step 82 of FIG. 3, the heater having the new surface feature can be used to perform the process on the substrate according to the process conditions (step 84). For example, the process may involve forming a layer on the substrate by introducing a process gas into the process chamber, heating the substrate with the heater, and generating a pressure in the pressure chamber. Additional energy may also be introduced into the process chamber to form the layer. Any suitable apparatus may be used. One example is the Producer Chamber available from Applied Materials, Inc., Santa Clara, Calif. A description of the chamber is found in U.S. Pat. No. 5,855,681, which is incorporated herein by reference in its entirety.

An example of a heater surface 11 having the desired surface feature is shown in FIG. 1. The heater may be made of any suitable material, including aluminum nitride or the like. The process to be performed on the substrate is the deposition of an undoped silicate glass (USG) layer to achieve a uniform thickness. The process gases include nitrogen, helium, oxygen, ozone, and TEOS. The chamber pressure is about 400 Torr and the heater setting for the deposition temperature is about 540° C. The depths of the vacuum grooves (20-24) range from about 0.08 mm to about 0.4 mm. In one specific embodiment, the linear vacuum grooves (21-24) have a depth of about 0.1 mm, and the outer circular vacuum groove 20 has a depth of about 0.1 mm. The width of the vacuum grooves is typically about 0.76 mm (0.03 inch). The surface roughness of the heater surface 11 is typically between about 25 and about 50 micro-inches, and is desirably about 40 micro-inches in one specific embodiment. Over most of the substrate, the interfacial gas between the heater surface and the substrate is in free molecular state and thus the thermal conductivity is dependent on pressure. The configuration of the vacuum grooves has a significant effect on the thermal coupling between the heater surface and the substrate. The heater surface 11 having the above surface feature has been shown to produce an improved USG layer thickness uniformity to less than about 1.5%.

The above-described arrangements of apparatus and methods are merely illustrative of applications of the principles of this invention and many other embodiments and modifications may be made without departing from the spirit and scope of the invention as defined in the claims. The scope of the invention should, therefore, be determined not with reference to the above description, but instead should be determined with reference to the appended claims along with their full scope of equivalents.

What is claimed is:

1. A method of achieving a desired process uniformity of processing a substrate which is heated by a heater, the method comprising:
establishing a correlation between a uniformity parameter of the process to be performed on the substrate and a surface feature of a heater surface of the heater which is in substantially full contact with a bottom surface of the substrate; and
determining a desired surface feature of the heater surface of the heater in substantially full contact with the substrate, based on the correlation between the uniformity parameter of the process to be performed on the substrate and the surface feature of the heater surface of the heater, to achieve a preset process uniformity of the uniformity parameter.

2. The method of claim 1 wherein establishing the correlation between the uniformity parameter of the process and the surface feature comprises:
determining a correlation between the uniformity parameter of the process and a temperature of the substrate; and
determining a correlation between the temperature of the substrate and the surface feature of the heater surface.

3. The method of claim 2 wherein determining a correlation between the uniformity parameter of the process and the temperature of the substrate comprises:
obtaining test data from a plurality of tests each conducted by performing the process on a substrate, varying the temperature of the substrate, and measuring the uniformity parameter of the process performed on the substrate; and
establishing the correlation between the uniformity parameter of the process and the temperature of the substrate based on the obtained test data.

4. The method of claim 2 wherein determining the correlation between the temperature of the substrate and the surface feature of the heater surface comprises:
obtaining test data from a plurality of tests each conducted by performing the process on a substrate, varying the surface feature of the heater surface, and measuring the temperature of the substrate; and
establishing the correlation between the temperature of the substrate and the surface feature of the heater surface based on the obtained test data.

5. The method of claim 1 wherein determining desired surface feature of the heater surface comprises:
performing numerical simulation each by simulating heat transfer between the heater and the substrate for the process to be performed on the substrate;
varying the surface feature of the heater surface; and
calculating the uniformity parameter of the process to be performed on the substrate, based on the correlation between the uniformity parameter of the process to be performed on the substrate and the surface feature, until the preset uniformity is achieved for a simulated surface feature of the heater surface.

6. The method of claim 5 wherein calculating the uniformity parameter comprises:
determining a pressure distribution between the heater surface and the substrate from the numerical simulation;
calculating a Knudsen number distribution between the heater surface and the substrate based on the pressure distribution;
estimating a thermal conductivity distribution of a gas between the heater surface and the substrate based on the Knudsen number distribution; and
computing the uniformity parameter based on the thermal conductivity distribution of the gas and a heater temperature distribution of the heater.

7. The method of claim 6 wherein computing the uniformity parameter comprises calculating a substrate temperature distribution.

8. The method of claim 1 wherein the uniformity parameter comprises a thickness of a layer to be formed on the substrate.

9. The method of claim 1 wherein at least about 90% of the bottom surface of the substrate is in contact with the heater surface.

10. The method of claim 1 wherein the surface feature comprises at least one of a surface roughness of the heater surface and a depth of at least one vacuum groove on the heater surface.

11. The method of claim 1 wherein the heater surface includes a first vacuum port and a second vacuum port disposed on opposite sides of a heater center which is configured to be aligned with a center of the substrate, and wherein the heater surface comprises a first pair of vacuum grooves extending substantially linearly from the first vacuum port toward a periphery of the heater and being spaced apart by about 90°, and a second pair of vacuum grooves extending substantially linearly from the second vacuum port toward the periphery of the heater and being spaced apart by about 90° and generally opposite from the first pair of vacuum grooves.

12. The method of claim 11 wherein the heater surface includes a substantially circular outer vacuum groove which is coupled with the first pair of vacuum grooves and the second pair of vacuum grooves.

13. A method of performing a process with a desired uniformity on a substrate, the method comprising:
providing a heater to heat the substrate in a process chamber, the heater having a heater surface in substantially full contact with a bottom surface of the substrate, the heater surface having a surface feature which has been determined to achieve a preset uniformity of a uniformity parameter of a process to be performed on the substrate under a set of process conditions, based on a correlation between the uniformity parameter of the process to be performed on the substrate and the surface feature of the heater surface; and
performing the process on the substrate having the preset uniformity of the uniformity parameter according to the set of process conditions.

14. The method of claim 13 wherein performing the process comprises forming a layer on the substrate.

15. The method of claim 14 wherein the uniformity parameter comprises a thickness of the layer on the substrate.

16. The method of claim 13 wherein the surface feature comprises at least one of a surface roughness of the heater surface and a configuration of at least one vacuum groove on the heater surface.

17. The method of claim 13 wherein the surface feature of the heater surface of the heater is determined by:
performing numerical simulation each by simulating heat transfer between the heater and the substrate for the process to be performed on the substrate;
varying the surface feature of the heater surface; and
calculating the uniformity parameter of the process to be performed on the substrate, based on the correlation between the uniformity parameter of the process to be performed on the substrate and the surface feature, until the preset uniformity is achieved for a simulated surface feature of the heater surface.

18. The method of claim 17 wherein calculating the uniformity parameter comprises:
determining a pressure distribution between the heater surface and the substrate from the numerical simulation;
calculating a Knudsen number distribution between the heater surface and the substrate based on the pressure distribution;
estimating a thermal conductivity distribution of a gas between the heater surface and the substrate based on the Knudsen number distribution; and
computing the uniformity parameter based on the thermal conductivity distribution of the gas and a heater temperature distribution of the heater.

19. A method of achieving a desired uniformity of a process to be performed on a substrate which is heated by a heater, the method comprising:
modifying a heater surface of the heater in substantially full contact with a bottom surface of the substrate according to a surface feature which has been determined to achieve a preset uniformity of a uniformity parameter of a process to be performed on the substrate, by performing numerical simulation each by simulating heat transfer between the heater and the substrate for the process to be performed on the substrate; varying the surface feature of the heater surface; and calculating the uniformity parameter of the process to be performed on the substrate, based on the correlation between the uniformity parameter of the process to be performed on the substrate and the surface feature, until the preset uniformity is achieved for a simulated surface feature of the heater surface.

20. The method of claim 19 wherein the correlation between the uniformity parameter of the process and the surface feature is determined by determining a correlation between the uniformity parameter of the process and a temperature of the substrate, and determining a correlation between the temperature of the substrate and the surface feature of the heater surface.

21. The method of claim 20 wherein the correlation between the uniformity parameter of the process and the temperature of the substrate is determined by:
obtaining test data from a plurality of tests each conducted by performing the process on a substrate, varying the temperature of the substrate, and measuring the uniformity parameter of the process performed on the substrate; and
establishing the correlation between the uniformity parameter of the process and the temperature of the substrate based on the obtained test data.

22. The method of claim 20 wherein the correlation between the temperature of the substrate and the surface feature of the heater surface is determined by:
obtaining test data from a plurality of tests each conducted by performing the process on a substrate, varying the surface feature of the heater surface, and measuring the temperature of the substrate; and
establishing the correlation between the temperature of the substrate and the surface feature of the heater surface based on the obtained test data.

23. The method of claim 19 wherein the surface feature comprises at least one of a surface roughness of the heater surface and a configuration of at least one vacuum groove on the heater surface.

24. A heater for heating a substrate in a chamber for forming a layer on the substrate from a process gas, the heater comprising:
a heater surface configured to support the substrate, the heater surface including at least one vacuum port to be coupled to a vacuum source to draw a bottom surface of the substrate toward the heater surface, the heater surface having at least one vacuum groove extending from the at least one vacuum port,
wherein the heater surface has a surface topography to provide substantially full contact between the heater surface and the bottom surface of the substrate and a Knudsen number distribution of a gas between the heater surface and the bottom surface of the substrate which is greater than about 10 over a substantial portion of the bottom surface of the substrate; and
wherein the at least one vacuum groove has a depth and a pattern selected to produce a pressure distribution which gradually increases from a center region to a periphery of the heater surface.

25. The heater of claim 24 wherein the heater surface is in contact with the substrate over about 90% of the substrate bottom.

26. The heater of claim 24 wherein the at least one vacuum groove has a depth of about 0.08 to about 0.4 mm.

27. The heater of claim 24 wherein the surface roughness is about 25 to about 50 micro-inches.

28. The heater of claim 24 wherein the heater surface includes a first vacuum port and a second vacuum port disposed on opposite sides of a heater center which is configured to be aligned with a center of the substrate; and wherein the heater surface comprises a first pair of vacuum grooves extending substantially linearly from the first vacuum port toward the periphery of the heater surface and being spaced apart by about 90°, and a second pair of vacuum grooves extending substantially linearly from the second vacuum port toward the periphery of the heater surface and being spaced apart by about 90° and generally opposite from the first pair of vacuum grooves.

29. The heater of claim 24 wherein the Knudsen number distribution of a gas between the heater surface and the bottom surface of the substrate is greater than about 10 over at least about 90% of the bottom surface of the substrate
